(19) United States
(12) Patent Application Publication
(10) Pub. No.: US 2016/0050890 A1
(43) Pub. Date: Feb. 25, 2016

(54) Charging a Device Supported by an Animal

(71) Applicant: Aprium Tech Limited, London (GB)

(72) Inventors: Timothy Charles Andrew Fitzgerald, Godalming (GB); Kannan Michael Paul, London (GB); David Lee Sandbach, Brighton (GB); Robin Souter, London (GB); Peter Samuel Veash, London (GB)

(21) Appl. No.: 14/830,783

(22) Filed: Aug. 20, 2015

(30) Foreign Application Priority Data
Aug. 22, 2014 (GB) 1414935.5

(51) Int. Cl. A01K 29/00; H02J 7/00; A01K 27/00

(52) U.S. Cl. CPC A01K 29/005; A01K 27/003; H02J 7/0052

(57) ABSTRACT

The charging of an electrical device (101) supported by an animal is disclosed. The animal is walked on leash (103) and the leash is connected to the electrical device (101). When connected in this way, the electrical device is charged such that charge is available when the animal is released from the leash such that the electrical device may be operated.

### CROSS REFERENCE TO RELATED APPLICATIONS

This application claims priority from United Kingdom Patent Application 1414935.5 filed Aug. 22, 2014, the entire disclosure of which is incorporated herein by reference in its entirety.

### BACKGROUND OF THE INVENTION

1. Field of the Invention

The present invention relates to a method of charging an electrical device supported by an animal. The present invention also relates to an apparatus for tracking the position of an animal and an apparatus for tethering an animal.

2. Description of the Related Art

It is known to attach devices to animals that require electrical energy. Thus, a device may include a battery of electrical cells which may provide energy for an operational period. However, a problem arises in terms of the replacement or recharging of these cells on a regular basis.

For commercial and scientific applications, such measures would be included as part of an overall procedure. However, for domestic and emergency purposes, it is preferable to integrate the charging process within existing conventions and routines, such that it is not necessary to adopt a new regime in order to make use of the new functionality. In this way, the functionality will be available when required in an emergency situation, without introducing an unnecessary daily burden.

### BRIEF SUMMARY OF THE INVENTION

According to an aspect of the present invention, there is provided a method of charging an electrical device supported by an animal, comprising the steps of: walking an animal on a leash, wherein said leash is connected to an electrical device; charging said electrical device when connected to said leash; releasing the animal from said leash; and operating the electrical device after the animal has been released.

It is possible that the electrical device could include a capacitor, such as a super capacitor, capable of receiving charge during the charging step. However, in a preferred embodiment, the electrical device includes a first re-chargeable cell (or a battery of cells) and said first rechargeable cell is charged when the electrical device is connected to the leash.

It is possible that the recharging operation could be performed in response to mechanical movement. Thus, a cord could extend when walking an animal, to effect rotation of a drum and thereby generate energy via a dynamo. However, in a preferred embodiment, the leash includes a second re-chargeable cell and said second re-chargeable cell charges the first re-chargeable cell when the electrical device is connected to the leash.

In a preferred embodiment, the electrical device is a tracking device and the tracking device may be configured to process radio signals for location identification.

According to a second aspect of the present invention, there is provided an apparatus for tracking the position of an animal, comprising: a position detection device; a data transmission device; an energy storage device; and a leash connection device, wherein: said leash connection device is configured to physically restrain an animal; and said leash connection device is also configured to receive electrical energy from said leash to re-charge said energy storage device.

In an embodiment, the position detection device selectively uses satellite tracking and mobile telephony network tracking to provide position detection.

In an embodiment, the data transmission device selectively uses direct data communication and mobile telephony network communication to transmit position data to an operator.

According to a third aspect of the present invention, there is provided an apparatus for tethering an animal, comprising: a tether of which a first end is supported by an operator and a second end is connected to an animal-supported device having a first energy storage device; and means for charging said first energy storage device when the tether is connected to the animal-supported device.

In an embodiment, the tether includes a second energy storage device; and said second energy storage device is configured to charge said first energy storage device when the tether is connected to the animal-supported device.

### BRIEF DESCRIPTION OF THE DRAWINGS

FIG. 1 shows an apparatus for tracking the position of an animal;

FIG. 2 shows an animal being tracked after release;

FIG. 3 shows a protocol diagram representing data transmissions within the environment of FIG. 2;

FIG. 4 shows an example of a graphical display;

FIG. 5 shows an alternative graphical display defining a geo fence;

FIG. 6 details the collar and leash connected together;

FIG. 7 details the connector forming part of the leash; and

FIG. 8 shows the circuit inside the collar.

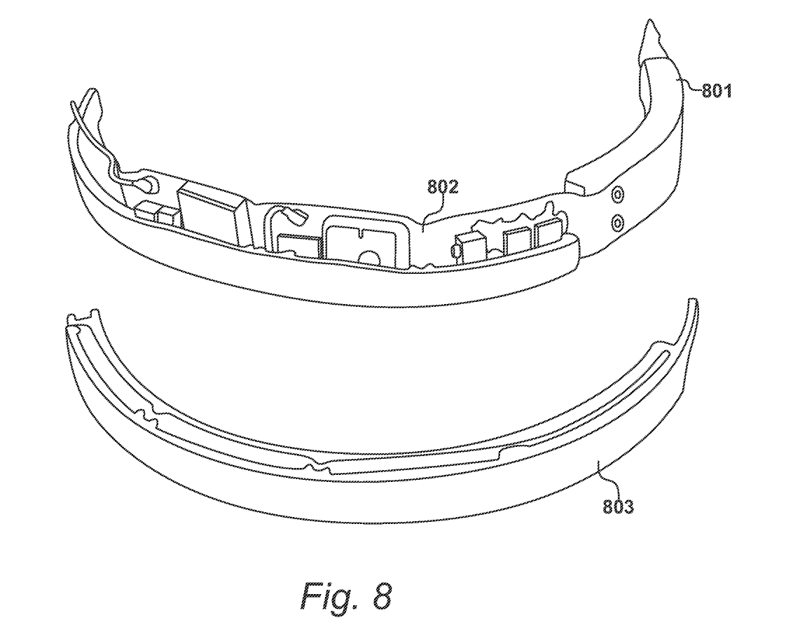

### DETAILED DESCRIPTION OF EXAMPLE EMBODIMENTS

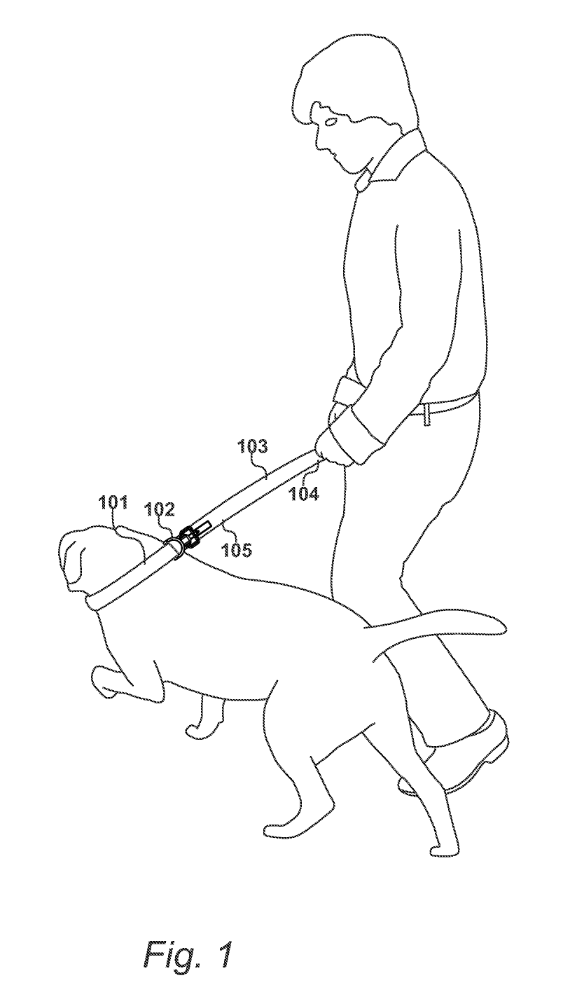

An apparatus 101 for tracking the position of an animal is shown in FIG. 1. The apparatus includes a position detection device, a data transmission device, an energy storage device and a leash connection device 102. The leash connection device is configured to physically restrain the animal. Furthermore, the leash connection device is also configured to receive electrical energy from a leash 103 to recharge the energy storage device.

In this way, the leash 103 is an example of apparatus for tethering an animal. The tether or leash 103 has a first end 104 supported by an operator and a second end 105 connected to an animal-supported device having a first energy storage device. The tether includes means for charging the first energy storage device when the tether is connected, as show in FIG. 1.

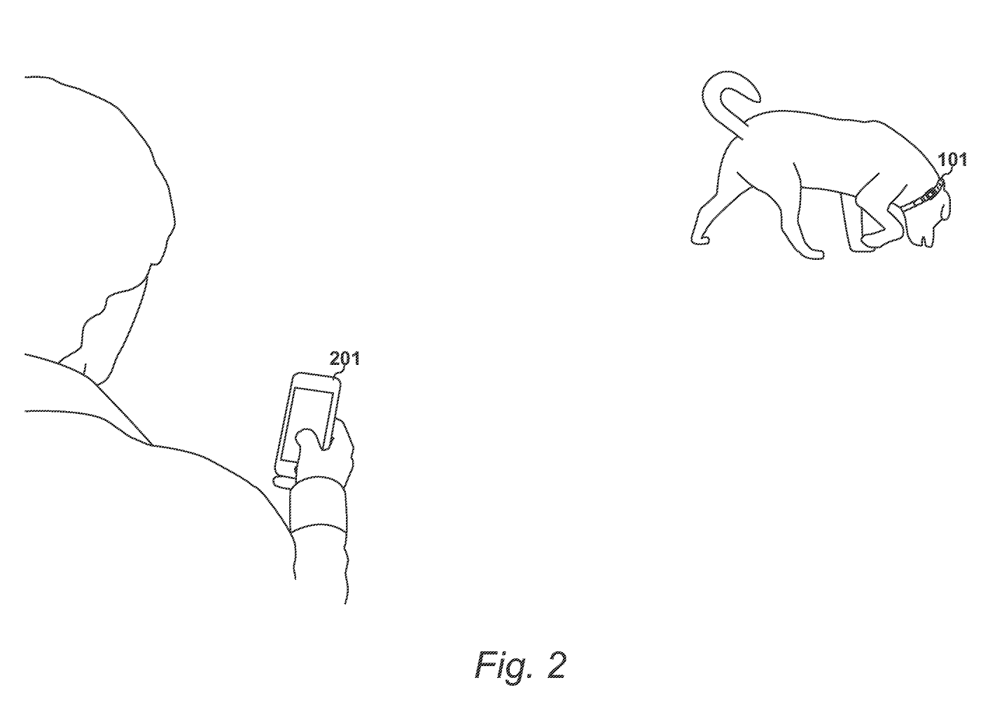

After releasing an animal from tether 105, the tracking apparatus 101 remains attached to the animal. In the embodiment shown in FIG. 2, the apparatus is embedded within a conventional looking collar therefore, unless inspected closely, the collar would be seen as being of a conventional design which would not be immediately noticeable to any unauthorised person looking to interfere with the animal.

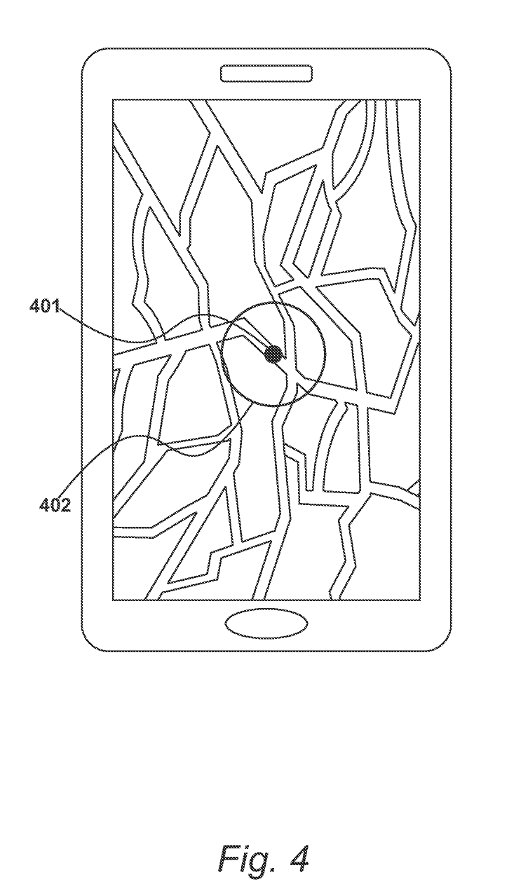

In this embodiment, the tracking device is primarily for emergency purposes. Thus, when dog walking for example, the dog will often remain in sight and will come back to an operator for re-tethering after leaving an area where it is possible for the animal to freely roam. However, situations may arise where the dog encounters unauthorised interference or, of its own volition, the dog may stray for a greater distance, which may in turn raise a concern on the part of the operator. Under these circumstances, it is possible for the operator to invoke an application on a mobile device 201 which will effectively locate the position of the lost animal. As shown in FIG. 4, this involves identifying the location of the tracking device and presenting this location on an appropriate graphical display, possibly including a map.

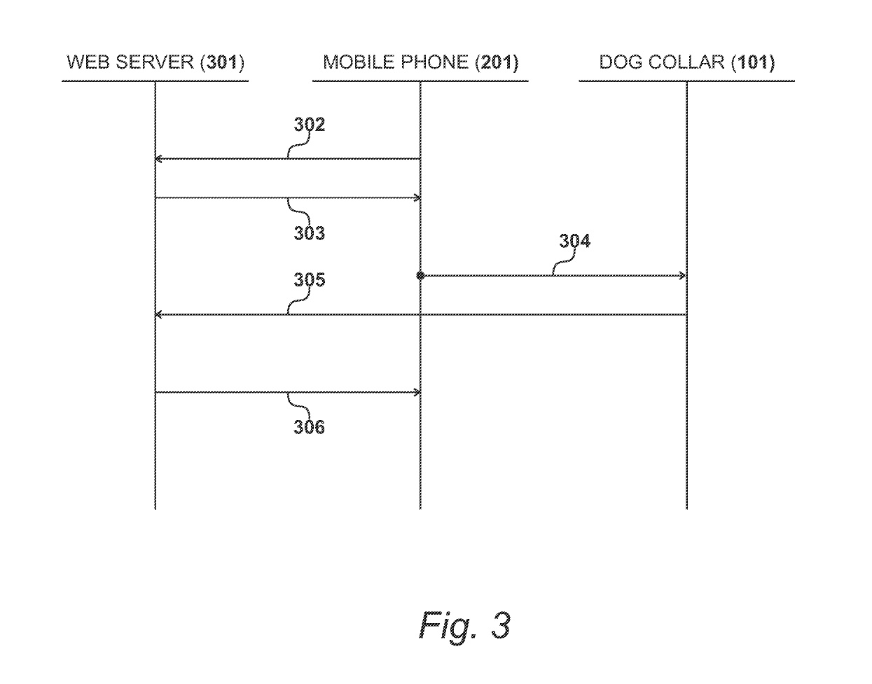

A protocol diagram is shown in FIG. 3, representing data transmissions within the environment of FIG. 2. To provide the required degree of functionality, the mobile phone 201 and the dog collar 101 communicate with a web server 301. When a user first obtains the device, a unique identification for the collar 101 is provided by a universal unique identifier; in a SIM card for the data modem operational within the mobile telephony network. A download link is created specifically for this unique identification, which provides the user with a preconfigured application, including the identification data. This ties the user to a specific collar.

Thus, as illustrated in FIG. 3, during an initialisation process, mobile phone 201 requests data at 302 from the web server 301. The web server 301 then returns the application at 303 to the mobile phone 201. The application is installed on the mobile phone 201, such that it is then possible for the mobile phone to communicate with the dog collar 101.

After installation, the user can operate the web application to make a request to identify the location of their animal. The web application generates an SMS from an authorised number that is then transmitted at 304 to the collar 101 via the unique phone number associated with the collar. The collar receives the SMS which in turn interrupts a micro controller from a low power state and opens a GPRS link to the web server 301.

At the web server 301, data is received at 305 via GPRS from the modem contained within the collar. In an embodiment, class 8 GPRS is used, which is a low power subset of the GPRS communications protocol.

Having established communication between the dog collar 101 and the web server 301, the web server 301 then sends location information and battery level information to the mobile phone 201, as shown at 306. The information is viewed on the mobile phone 201 via a browser or a specific phone application.

An example of a graphical display is illustrated in FIG. 4. In this embodiment, a location is indicated at 401, surrounded by a probability circle 402. In an embodiment, the colour of the probability circle may be adjusted to represent the type of location that has been used. Thus, if GPS is used the probability circle may be smaller and represent a greater degree of accuracy, compared to using a GSM phone network derived location.

In this embodiment, the primary function is not just to watch movement of an animal or to look at a history of movement. In this embodiment, the objective is not to continuously find the animal's location and send this back to the user. It is the intention of this embodiment to be used for emergency use. Thus, a degree of walking with the collar attached to the leash, of say ten minutes per day, provides sufficient battery energy within the collar to allow emergency tracking to be maintained for over a day. In addition, techniques are deployed in order to minimise battery consumption when not required.

As illustrated in FIG. 4, a map is displayed; and application program interfaces (APIs) for achieving this are known in the art. Furthermore, as is known in the art, it is possible to plot a route for the user from the location of the phone to the location of the animal, possibly just by walking or by including public transport. This first mode of operation may be identified as the “find my dog” mode.

In a second mode of operation, identified as a “stay” mode, it is possible for the dog to be left for relatively short periods of time, possibly tied up outside a shop for example. Under this mode of operation, a relatively small geo fence is established and an alert is raised if the dog moves outside of this geo fence.

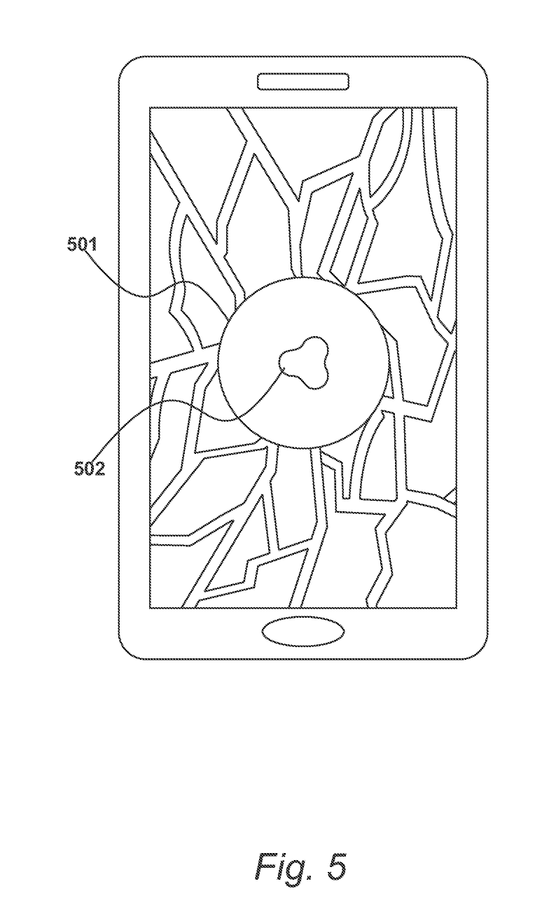

An example of a geo fence 501 is illustrated in FIG. 5. This illustrates a third mode of operation in which, as an alternative to a geo fence being created automatically, it is possibly for a user, via an appropriate graphical interface, to draw a geo fence. Thus, by manual operation upon the mobile phone, a user may establish a specific geo fence, from a starting indication 502.

In a fourth mode of operation, identified as a “stay close” mode, reliance is made upon a Bluetooth connection established between the mobile phone 201 and the collar 101. Under this mode of operation, an alarm is raised if the Bluetooth connection is lost. Thus, in practice, an alert will be raised if the dog is more than approximately fifty metres away from the user and therefore out of Bluetooth range.

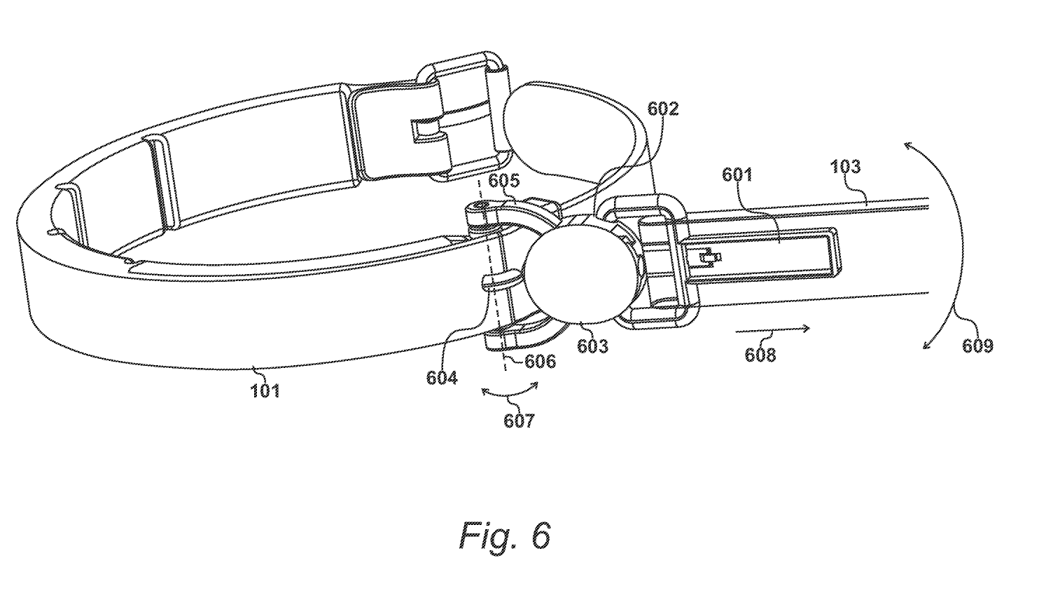

Collar 101, connected to leash 103, is detailed in FIG. 6. The arrangement provides for the charging of the collar supported by an animal, while walking the animal on a leash. The animal may then be released from the leash and electrical devices contained within the collar may be operated after the animal has been released. The collar includes a first rechargeable cell and this is charged when the electrical device is connected to the leash, as illustrated in FIG. 6. The leash includes a second rechargeable cell (or battery of cells) within a housing 601. Thus, in this embodiment, the second rechargeable cell (in the leash) charges the first rechargeable cell (in the collar) when connected, as shown in FIG. 6.

This configuration may be used for a tracking device and the tracking device may process radio signals for location identification. Thus, these radio signals may be derived from satellites, or ground based networks including the mobile telephony network.

The leash 103 wraps around the battery compartment 601 and in an embodiment, the battery consists of two 3.7V lithium polymer batteries connected in series to ensure that there is a sufficiently high charging voltage.

A charge management chip is included in the leash to control the charging of the secondary battery within the leash and the discharging of the secondary battery from the leash to the collar. In an embodiment, further charge management chips may be included within the collar.

A negative terminal from the battery is connected to a metal connector 602 and the positive terminal is connected to an insulated wire and in turn to a sprung ball or pogo pin (described below), in this figure hidden underneath a slideable cover 603. A stainless steel ball is provided within a crimped barrel, with a spring to push the ball outwards. This allows the ball to move, under compression, by a maximum extent of 0.8 mm in a configuration known as a pogo pin. The sprung ball rolls over a metal contact 604, extending from the collar 101. Metal contact 604 is rounded in two axes, such that it is possible for a D-buckle 605 to rotate about axis 606 in a direction illustrated by arrow 607, and/or about another axis in a second direction, for example by sliding around the circumference of the D-buckle, while maintaining electrical contact.

To attach and detach the collar, slideable cover 603 is slideable in the direction of arrow 608. When secured, as illustrated in FIG. 6, it is possible for the leash to move around the circumference of the D-buckle 605, in directions indicated by arrow 609.

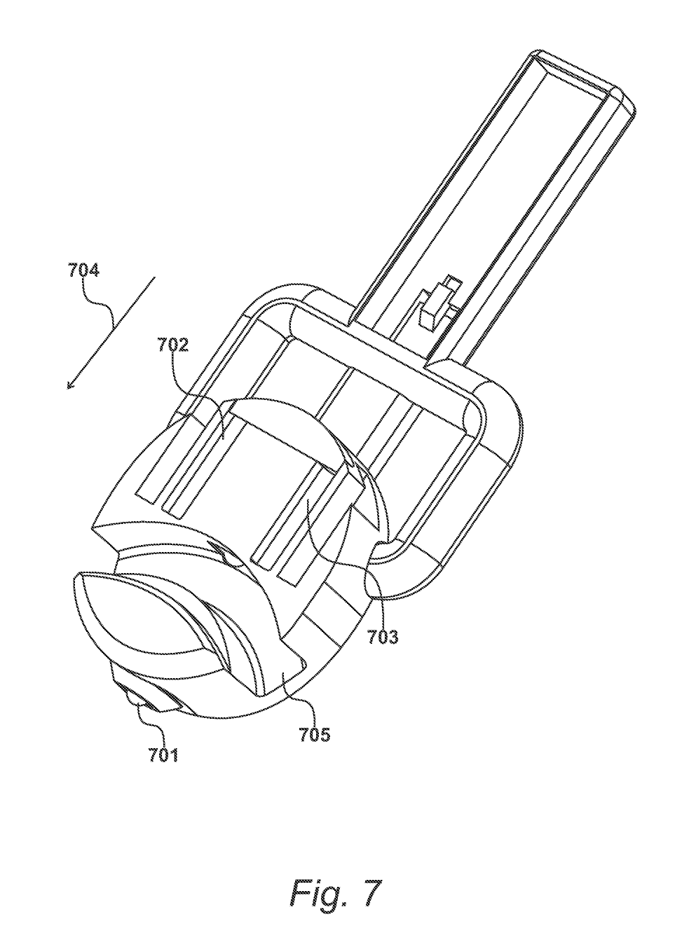

Connector 602, with cover 603 removed, is illustrated in FIG. 7. Stainless steel ball 701 is shown extending from the bottom of the connector which, as described, when connected, remains in contact with collar contact 604; even when movement occurs relatively between the collar and the leash. A first channel 702 and a second channel 703 each receive a respective compression spring, which force the slideable clip cover 603 in the direction of arrow 704, thereby maintaining the clip in a closed configuration, as illustrated in FIG. 6, unless manual force is applied, in the opposite direction to arrow 704, in order to reveal groove 705 for receiving D-ring 605. Both the body of connector 602 and the D buckle are manufactured from a polished, die-cast metal, such that the body of both have good electrical conductivity and a negative terminal connection is made, between the body of connector 602 and the D buckle 605 when mechanically connected together. The sprung stainless steel ball 701 is connected separately to a positive terminal and thus is in electrical contact with metal contact 604.

In areas where electrical connection is not required, insulation is provided to prevent shorting due to the presence of water, preferably by using a hydrophobic material.

During relative movement of the collar and the leash, electrical contact may be lost momentarily but will be reinstated in order to maintain a charging current from the leash to the collar.

In an alternative configuration, it would be possible to provide two electrically separated contacts on the D-ring or transmission could be achieved using an inductive coupling. Another possibility would be the provision of a dynamo in the collar. A spring drum would hold a cord such that the spring returns the cord back from a retracted state. Extension could occur for as little as 10 cm but repeated action would provide charging energy due to the action of the dog pulling and then releasing the leash.

In the collar, a leather strap forms the outside covering, which is stuck to a flexible over moulding. The electronics of the collar, representing the electrical device that requires charging, is contained within this moulding.

Inside the collar, there is a curved metal battery box 801 that connects to the D-ring 605 and the external terminal 604. The metal nature of this box provides mechanical protection and facilitates heat dissipation.

Energy, from the secondary battery contained within the leash, is conveyed to the primary battery within the collar via a charge management circuit. The leash may be charged relatively slowly from a mains transformer but it is preferable for the discharge from the leash to the collar to occur quickly; so as to provide as much current as possible during short connection times. Thus, it is intended that a ten minute walk should deliver enough energy for the collar battery to continue providing operational power for more than a whole day of average use. Thus, over time the primary battery in the collar obtains a little more energy each day than it uses on average, so that, over time, it can normally be expected to hold close to a full charge, available for emergency use. The battery in the collar should provide 340 mA hours, which should last for several days in an emergency. The secondary batteries in this embodiment provide 180 mAh and discharge at a high rate of >400 mA. Thus, during ten minutes of transfer of charge at 400 mA (after efficiency losses) approximately 67 mAh is transferred to the primary battery.

Thus, in operation, a tracking device transmits a radio signal and the radio signal is encoded to convey details of an identified location. A first mode of transmission provides a first type of radio signal encoding, such as low energy Bluetooth and a second mode of transmission provides a second type of signal encoding, such as GPRS. A selection is made between the first mode of transmission and the second mode of transmission, so as to maintain communication with an operator's mobile device. Bluetooth is prioritised in the selection process as a preferred means of data transfer, due to it's lower power consumption and it's exemption from GPRS network data charges.

A leash connector has been described that physically connects to a collar worn by an animal, so as to restrain the animal while also providing electrical energy to the electrical device. In an embodiment, the leash connector is also configured to receive electrical energy when recharging. Thus, it is envisaged that when not in use, the leash would be hung in a hallway for example or at any other position where conventional leashes would be hung; and while hung, it would receive electrical charge from a mains adaptor. Thus, the connector used for conveying electrical energy to the collar is also used for receiving electrical energy from the mains supply, given the provision of an appropriate interface on the leash end of the adaptor. Preferably, the same terminals of the leash connector of FIG. 6 are used for both input and output of electrical energy, and the selection of modes for charging or discharging the secondary batteries is managed by a circuit within the battery compartment 601.

The circuitry within the collar includes a PIC micro controller, a GPRS modem, a GPS navigation circuit, a Bluetooth low energy circuit and a charge management circuit. The components are mounted on a flexi circuit, consisting of rigid sections, onto which components are physically restrained, connected by flexible portions that allow the overall circuit to flex and adopt the substantially circular configuration required for the collar. The flexi circuit 802 is encapsulated in a flexible polymer 803 that is waterproof. A strip of Kevlar is added between the leather and the encapsulated flexi circuit to prevent stretching and improve overall mechanical durability. In particular, this arrangement provides a degree of protection for the circuit in situations where the collar may be bitten by another dog.

In a preferred embodiment, measures are taken to reduce collar power consumption. The GPS circuit may be a Quectel L76GPS/GNNS module, that can make use of extended ephemeris data downloaded from the internet. This provides a few days of pre-calculated satellite location data, thereby reducing the amount of time taken to obtain GPS locations when the module is woken from a low power state.

Current consumption of the GPS module is about 15 mA while acquiring a position and this is reduced greatly during idle periods, so increasing the idle periods reduces power consumption significantly.

The GPRS modem can also be put into various levels of sleep when it is not active, thereby significantly reducing collar energy consumption. The GPRS modem can remain in a particular sleep mode until woken up by an incoming text message.

The collar circuit is configured to detect when the secondary batteries are connected and various checks and measurements can be performed during this configuration, that is to say, when there is no shortage of power.

When the level of energy stored in the collars primary battery starts to run low, notifications may be sent to the user, informing a user that a battery recharge is required.

The various modes previously described can be enhanced by adding accelerometers to the collar. If the accelerometers indicate that there has been no significant movement for a certain period of time, it can be assumed that the animal is asleep and in one place, allowing the GPS module to be switched off or placed in a lower power state, in which position data is acquired less frequently.

In an embodiment, battery life is reported back to the user when they request the position of the animal. A calculated battery life can also be provided to the user on the application, without instigating a find action.

In an embodiment, if the owner is say four hours travel time away from the animal, the owner can instruct the collar to go into a low power state for a few hours, thereby saving stored energy in the collar; which can be powered up again in response to an internal timer or by sending a message to the collar from the application. The application instigates transmission of a suitable machine generated text message to the collar, so that the user does not actually have to send a text message themselves.

The flexi circuit 802 has clusters of components, and portions of flexi circuit, that will be rigidized by encapsulating them in a harder material before they are embedded within the softer encasing material 803. This harder material is not applied to the whole of the flexi circuit, so that unpopulated portions of the flexi circuit are left out, encouraging flexing in these unpopulated portions and reducing flexing in the populated functional portions.

A normal state for all modules in the collar is a low energy-dissipation state, in which current consumption is minimised while the modules are on standby. The GPS module has a relatively large ceramic antenna to provide very good reception with low power consumption. The GPS antenna may be located approximately opposite the heaviest portion of the collar, usually the battery enclosure, so that during most of the time in use, the GPS antenna faces upwards, thereby improving satellite reception. The GPS module is usually in its lowest power state but is ready to make a warm start and obtain a location on request within five to ten seconds; which can then be sent to the user to identify the location of the animal.

The micro controller may by default be switched off via a latching power transistor or, alternatively, it may be placed into a sleep mode.

The Bluetooth low energy modem makes a connection to the operator's phone and during periods when the Bluetooth modem indicates that the phone is nearby, various modules of the collar circuit can be switched into low power sleep modes.

To operate the collar, bringing it out of its sleep modes, an SMS message is received causing the micro controller to wake up. The micro controller confirms whether the SMS has arrived from an authorised number by checking the number against a list stored in the micro controller's flash memory. This checks that the collar has been triggered by the application running on the operator's phone and prevents triggering from SMS messages received from other sources.

The micro controller checks the status of the GPS signal to see whether it is possible to get good location estimates. This is generally more accurate than GSM triangulation but the latter can be used as a fall back source of location information should GPS be unavailable.

GSM triangulation involves registering with each visible cellular base station and requesting information such as signal strength and timing advance. Thereafter, multilateration is used to calculate the approximate position of the collar.

It is also possible for a piezo sounder to be included in the collar for user interactions. An audible beep could be generated to confirm that power is available. Furthermore, audio could be used for dog training purposes. Thus, if a dog goes out of range of say more than 50 m from the user (for example when in “stay close” mode of operation) the dog would hear a noise from the collar. This could be recognised and the dog could be trained by providing a treat when it returns.

What we claim is:

1. A method of charging an electrical device supported by an animal, comprising the steps of:
walking an animal on a leash, wherein said leash is connected to an electrical device;
charging said electrical device when connected to said leash;
releasing the animal from said leash; and
operating the electrical device after the animal has been released.

2. The method of claim 1, wherein:
said electrical device includes a first re-chargeable cell; and
said first re-chargeable cell is charged when the electrical device is connected to the leash.

3. The method of claim 2, wherein:
the leash includes a second re-chargeable cell; and
said second re-chargeable cell charges the first re-chargeable cell when the electrical device is connected to the leash.

4. The method of claim 1, wherein said electrical device is a tracking device.

5. The method of claim 4, wherein said tracking device processes radio signals for location identification.

6. The method of claim 5, wherein said tracking device transmits a radio signal and said radio signal is encoded to convey details of an identified location.

7. The method of claim 6, wherein:
a first mode of transmission provides a first type of radio signal encoding;
a second mode of transmission provides a second type of signal encoding; and
a selection is made between said first mode of transmission and said second mode of transmission so as to maintain communication with an operator.

8. The method of claim 4, wherein an identified location is presented to an operator via a graphical interface displayed on a mobile communication device.

9. The method of claim 1, wherein said leash includes a leash-connector for physically connecting to a collar worn by an animal so as to restrain said animal while also providing electrical energy to said electrical device.

10. The method of claim 9, wherein said leash-connector is also configured receive electrical energy when re-charging.

11. Apparatus for tracking the position of an animal, comprising:
a position detection device;
a data transmission device;
an energy storage device; and
a leash connection device, wherein:
said leash connection device is configured to physically restrain an animal; and
said leash connection device is also configured to receive electrical energy from said leash to re-charge said energy storage device.

12. The apparatus of claim 11, wherein said position detection device selectively uses satellite tracking and mobile telephony network tracking to provide position detection.

13. The apparatus of claim 11, wherein said data transmission device selectively uses direct data communication and mobile telephony network communication to transmit position data to an operator.

14. The apparatus of claim 11, wherein said mobile telephony network conveys data to a mobile device via a server system.

15. The apparatus of claim 14, wherein said leash connection device facilitates movement between a collar and a leash while maintaining electrical connection.

16. Apparatus for tethering an animal, comprising:
a tether of which a first end is supported by an operator and a second end is connected to an animal-supported device having a first energy storage device; and
means for charging said first energy storage device when the tether is connected to said animal-supported device.

17. The apparatus of claim 16, wherein:
said tether includes a second energy storage device; and
said second energy storage device is configured to charge said first energy storage device when the tether is connected to the animal-supported device.

18. The apparatus of claim 17, wherein the tether includes a tether-connector for connecting to said animal-supported device, thereby restraining the animal and conducting electrical energy to the animal supported device.

19. The apparatus of claim 18, wherein said tether-connector facilitates movement between the tether and a collar.

20. The apparatus of claim 18, wherein said tether-connector is also configured to receive electrical energy.
